(19) United States
(12) Patent Application Publication
(10) Pub. No.: US 2019/0063502 A1
(43) Pub. Date: Feb. 28, 2019

(54) DEVICE AND METHOD FOR MONITORING A DEVICE WITH A SLIDING BEARING DEVICE

(71) Applicant: Rolls-Royce Deutschland Ltd & Co KG, Blankenfelde-Mahlow (DE)

(72) Inventor: Rudolf LUECK, Nuthetal-Rehbruecke (DE)

(21) Appl. No.: 16/058,626

(22) Filed: Aug. 8, 2018

(30) Foreign Application Priority Data
Aug. 23, 2017 (DE) 10 2017 119 305.7

(51) Int. Cl. F16C 41/00; F16C 17/12; G01P 3/44; G01D 5/14; G01D 5/16; G01B 7/14; G01B 7/30

(52) U.S. Cl. CPC F16C 41/007; F16C 17/12; G01P 3/443; F16C 2360/23; G01D 5/16; G01B 7/14; G01B 7/30; G01D 5/142

(57) ABSTRACT

A device for monitoring a device with a sliding bearing device with a static element for an element movable in a rotatory manner relative to the static element. The movable element has a device for generating a magnetic field and the static element has at a sensor device for detecting the magnetic field, in particular a time-varying magnetic field, wherein data of the magnetic field that is detected, in particular in a contact-free manner, by the sensor device can be transmitted to a data processing device, and a statistic for a spatial arrangement of the static element relative to the movable element can be determined with the data processing device based on the detected data. The invention includes a method for monitoring the device with the sliding bearing device.

This application claims priority to German Patent Application DE102017119305.7 filed Aug. 23, 2017, the entirety of which is incorporated by reference herein.

The invention relates to a device for monitoring a device with a sliding bearing device having the features of claim 1 and a method for monitoring a device with a sliding bearing device having the features of claim 12.

Sliding bearings serve for guiding and/or mounting elements that are movable with respect to one another in a manner that is as precise, low-friction and wear free as possible. Here, the sliding bearings can be embodied as statically or dynamically loaded axial or radial bearings. The sliding bearings can also be embodied to be sectioned or subdivided, wherein a sectioned embodiment can facilitate the installation of the sliding bearing in a device.

Sliding bearings are widely used, e.g. in internal combustion engines (e.g. crank shaft, big end, small end or camshaft bearings), in compressors, pumps, gear boxes, turbines or generators. Sliding bearings are also used in aircraft engines, here e.g. in planetary gears that are switched between a driving turbine section (e.g. a low-pressure turbine) and a fan. The planetary wheels in these planetary gears are e.g. mounted by means of sliding bearings. Here, planetary gears represent a special design of epicyclic gearings, i.e. gear boxes that have axles running on a circular orbit inside the frame in addition to shafts that are fixed to the frame.

At that, it is of interest with respect to the operation of the device to respectively determine the current spatial arrangement of the static element (e.g. a shaft for a planetary wheel) relative to the movable element (e.g. the planetary wheel). It is also of interest to determine the spatial arrangement of a movable shaft relative to a static sliding bearing.

Here, the spatial arrangement e.g. comprises the clearance, i.e. the gap between the sliding bearing and the mounted part. The knowledge of the current clearance can be used for determining the state of wear or an irregular operational state.

Another parameter of the spatial arrangement of a static element and an element that is movable relative thereto is the radial and/or axial alignment of the axle, e.g. an inclination of the shaft axis with respect to the axis of the sliding bearing (e.g. tilting). The rotational speed and/or the rotational direction also allow to make statement about the relative spatial arrangement of the elements with respect to each other. The spatial arrangement e.g. also includes the relative positions of planetary wheels, e.g. relative to a carrier or a housing.

These current spatial arrangements (i.e. the values measured during operation) can be used on their own or in combination for monitoring the operational safety.

Thus, there is the objective to create devices and methods for monitoring devices with sliding bearing devices.

The device according to claim 1 addresses this objective.

Here, the at least one movable element has at least one device for generating a magnetic field. The at least one static element has at least one sensor device for detecting the magnetic field, in particular a time-varying magnetic field.

The data of the magnetic field (e.g. in the form of induced voltage signals U(t)) that are detected by the sensor device in particular in a contact-free manner can be transmitted to a data processing device during operation of the at least one device.

Depending on the detected data, at least one statistic for a spatial arrangement of the at least one static element relative to the at least one movable element can be determined with the data processing device.

Here, the term of spatial arrangement has to be understood not only in a static, but also in a dynamic sense. Thus, in one embodiment, the spatial arrangement between the at least one static element and the at least one movable element can be characterized by the clearance between the at least one static element and the at least one movable element. This may e.g. be a value that is of interest during the operation of sliding bearings.

Additionally or alternatively, a measure for the alignment, in particular the axial alignment, the radial alignment and/or orientation between the at least one static element and the at least one movable element, a phasing, a rotational direction of the at least one movable element and/or the rotational speed of the at least one movable element can be used. The phasing can e.g. be of use in connection with the use in a planetary gear. When the teeth are deformed, a change of the phasing will be observable based on the received signal.

In a further embodiment, the device for generating a magnetic field can have at least one magnet element, in particular at least one magnet element that is enclosed in the at least one movable element, a magnetized area that is externally introduced into the movable element, at least one coil that is enclosed in the at least one movable element and/or at least one permanent magnet or magnetic area enclosed in the at least one movable element. All these means create a magnetic field that can subsequently be detected by the sensor device.

In one embodiment, the device for generating the magnetic field has a coded arrangement with magnet elements for the differentiation of the rotational direction of the movable element and/or for the individualization of the at least one movable element. The coding can e.g. be based on a targeted asymmetrical arrangement or sequence of magnet elements or magnetic areas. Such a coding can e.g. also be present in the form of a thin layer that has differently magnetized areas, as it is e.g. known from hard drives or audio tape material.

In one embodiment, the at least one device for generating a magnetic field is at least partially arranged across the axial width of the at least one sliding bearing device in order to be able to make statements, e.g. regarding the orientation of the shaft axis.

In a further embodiment, the sensor device has at least one coil for detecting the magnetic field, in particular the time-varying magnetic field, at least one Hall sensor, a magnetic reading head and/or at least one magnetoresistive sensor.

In one embodiment, it is also possible for the data processing device to determine the amplitude curve of the time-varying magnetic field. This may e.g. be performed by analyzing the voltage signal U(t) induced by the magnetic field.

A possible field of application for embodiments are planetary gears in which the at least one static element is a carrier (i.e. a planetary wheel support) in the planetary gear, and the at least one sensor device is arranged at the carrier. In this manner, the spatial arrangements of the planetary wheels relative to the carrier can be detected. Here, in particular the at least one device for generating a magnetic field can be arranged at least at one planetary wheel of the planetary gear, so that a movement of the at least one planetary wheel relative to the carrier can be detected by at least one sensor device at the carrier.

It is also possible that the at least one static element is a housing of the planetary gear or is arranged at the same, and the carrier is the element that is movable relative to the housing, so that a relative movement of the carrier with respect to the housing can be detected by the at least one sensor device. In this manner, e.g. the spatial arrangement of the carrier with the planetary wheels that are rotating inside the hollow wheel can be detected.

These devices can be used in a turbomachine, in particular an aircraft engine.

A method with the features of claim 12 also addresses this objective.

Here, the at least one movable element generates a magnetic field by means of at least one device.

The at least one static element has at least one sensor device for detecting the magnetic field, in particular a time-varying magnetic field.

The date obtained with the at least one sensor device, in particular data of the magnetic field of the device detected in a contact-free manner, are transmitted to a data processing device, and the data processing device determines at least one statistic for a spatial arrangement of the at least one static element relative to the at least one movable element based on the detected data.

The invention is explained in connection with the exemplary embodiments shown in the Figures. In the drawings:

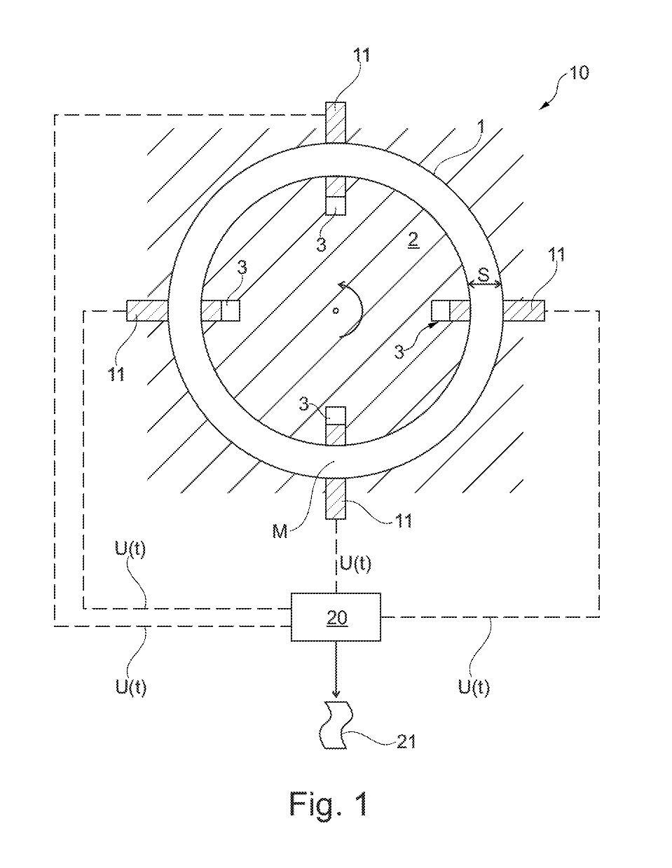

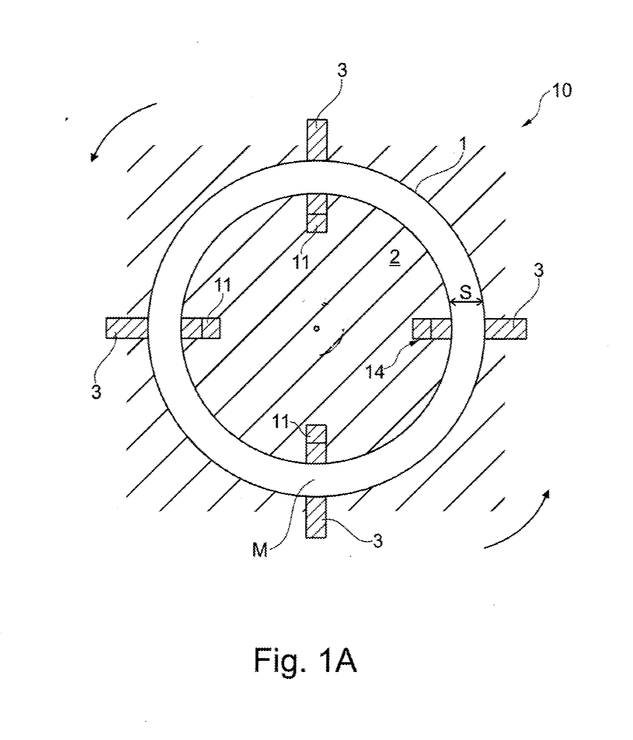

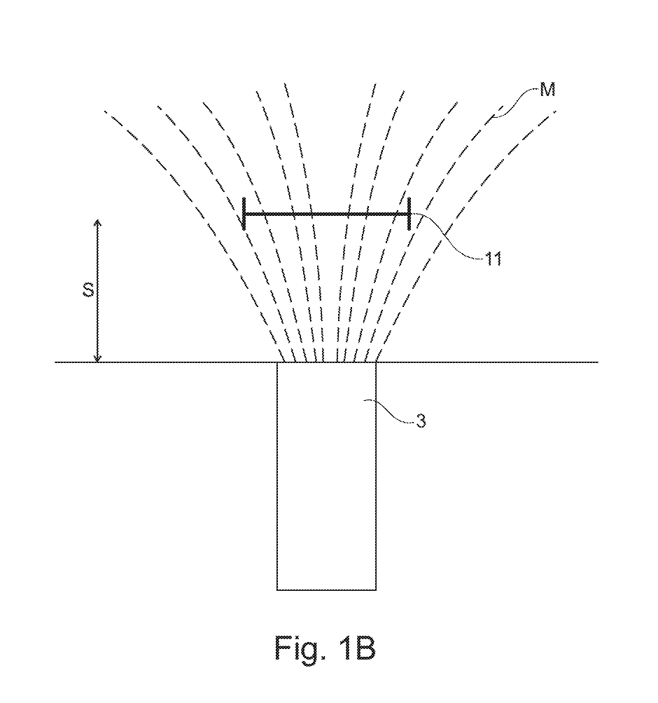

FIG. 1 shows a schematic sectional view through an embodiment of a device with a sliding bearing device for mounting a shaft;

FIG. 1A shows a schematic sketch for explaining the amplitude;

FIG. 1B shows a schematic sectional view through an alternative design to the embodiment according to FIG. 1;

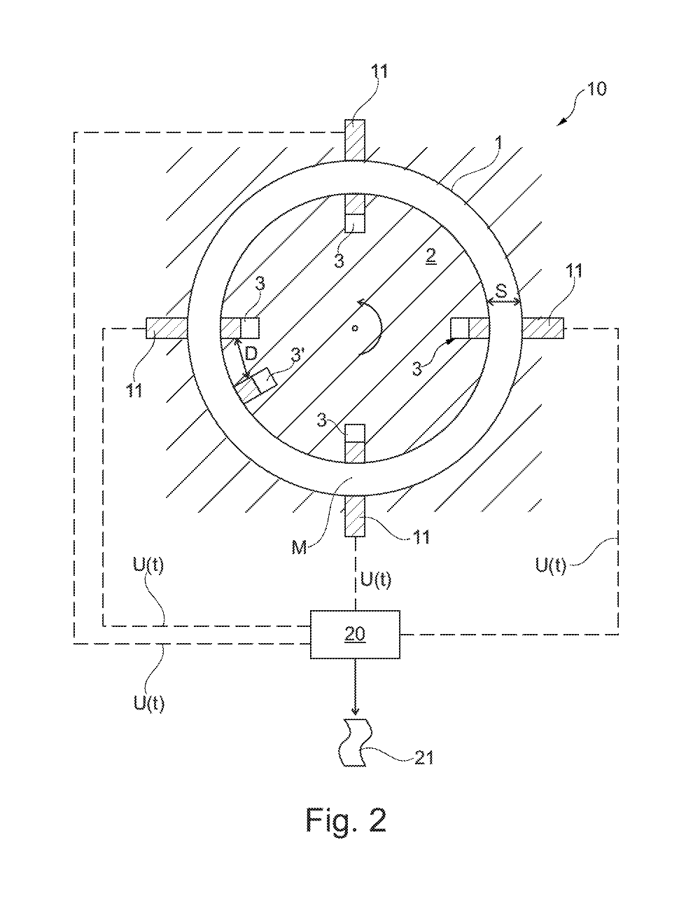

FIG. 2 shows a schematic sectional view of a variation of the embodiment according to FIG. 1;

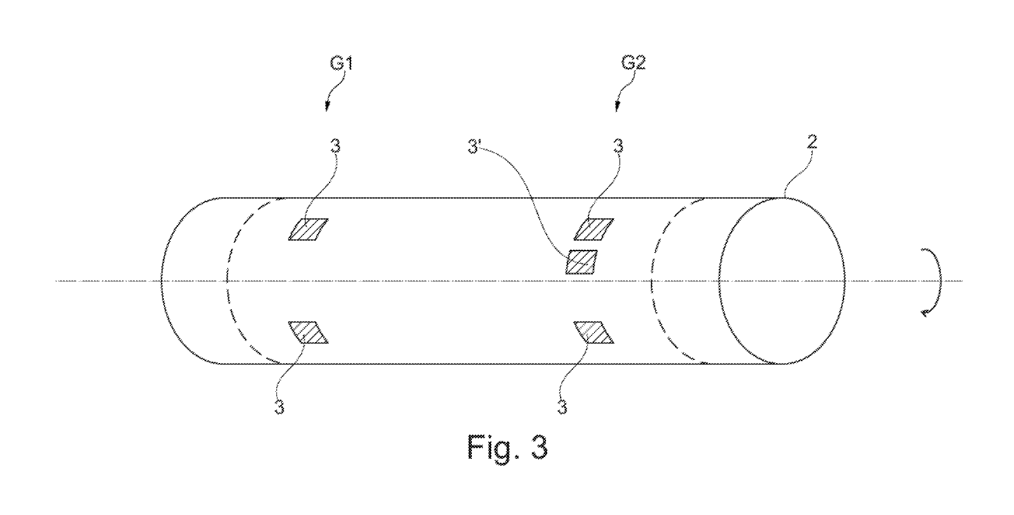

FIG. 3 shows a schematic view of a shaft with two axially distributed groups of devices for generating a magnetic field;

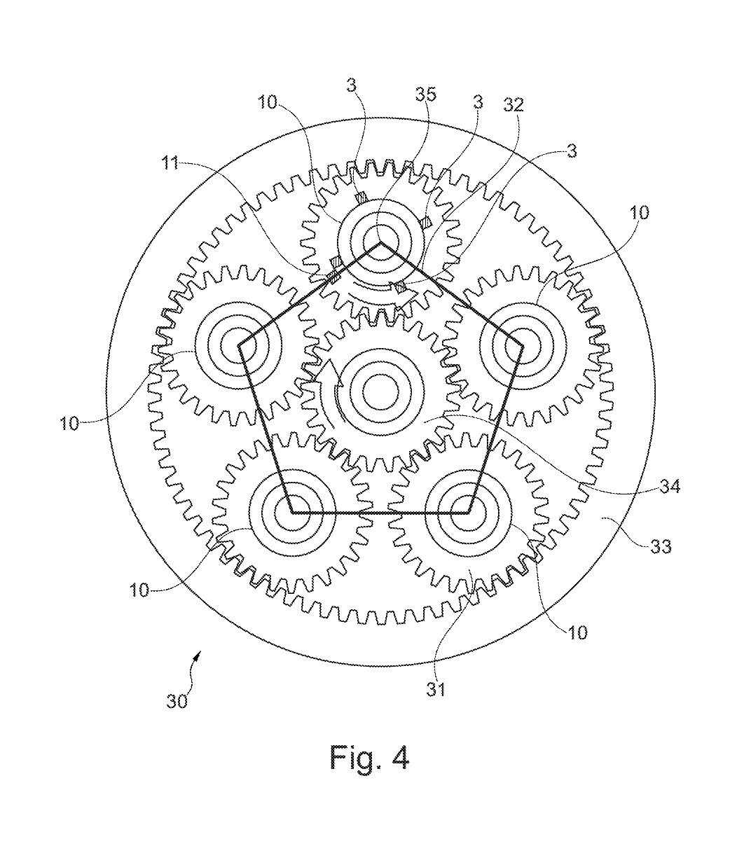

FIG. 4 shows a schematic view of a planetary gear with an embodiment for monitoring a device with sliding bearing devices;

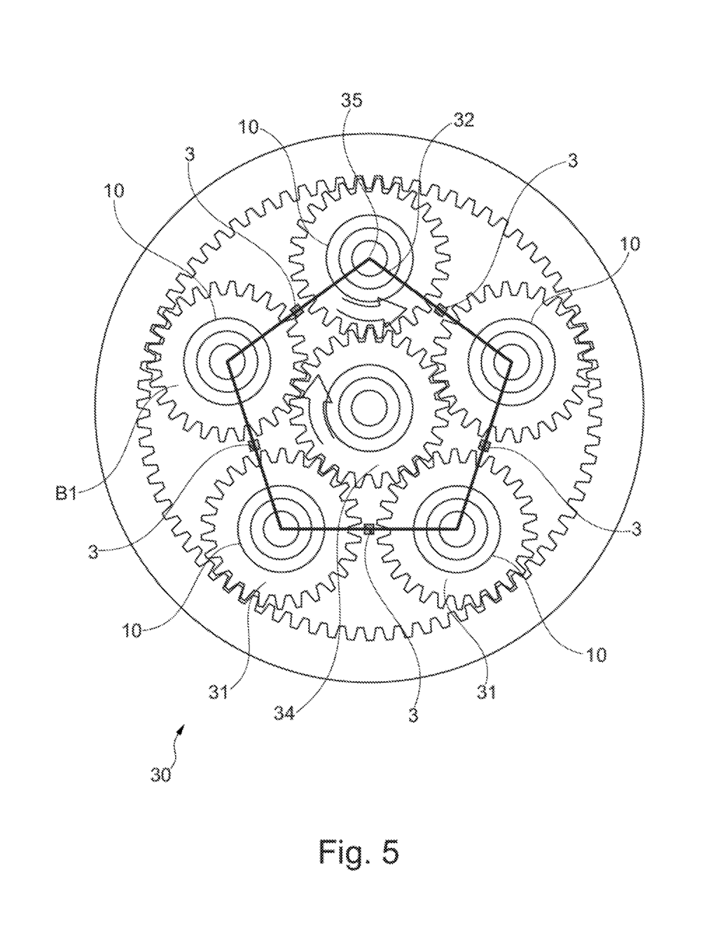

FIG. 5 shows a schematic view of a planetary gear with a further embodiment of a device for monitoring a device with sliding bearing devices;

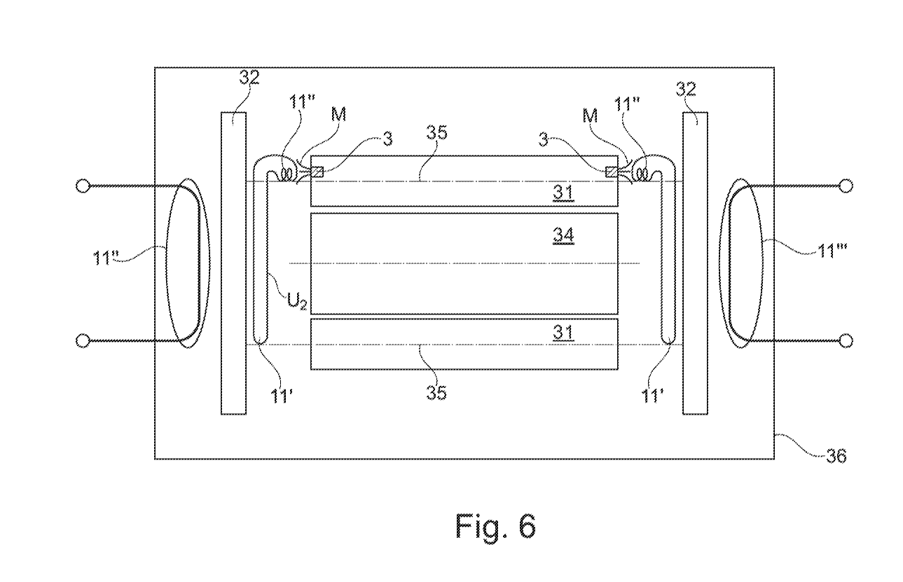

FIG. 6 shows a schematic side view of a planetary gear with a further embodiment of a device for monitoring a device with siding bearing devices.

FIG. 1 shows an embodiment of a device with a sliding bearing device 10. In principle, devices of this kind can e.g. be used in planetary gears, as will be illustrated in the following in FIGS. 4, 5 and 6.

The sliding bearing device 10 has a static element 1, here the sliding bearing shell. In this sliding bearing 1, a shaft 2 is arranged in a rotatable manner as the movable element. Thus, the shaft 2 is movable relative to the sliding bearing 1.

Here, FIG. 1 is supposed to show only one possible configuration of the elements 1, 2.

The sliding bearing gap with the clearance S is shown between the sliding bearing 1 and the shaft 2, wherein the clearance S is shown to be disproportionally large with a view to clarity.

Here, multiple devices 3 for generating magnetic fields M (shown in FIG. 1 only schematically) are arranged at the circumference in the shaft 2. These devices 3 for generating magnetic fields M can e.g. have permanent magnets that are embedded in the shaft 2. Also, magnetized areas of the devices 3 for generating the magnetic fields M can be introduced into the shaft 2 by means of external magnetization. In principle, it is also possible for the device 3 for generating a magnetic field M to comprise electromagnetic elements (e.g. coils). A combinations of the magnetic means is also conceivable.

In the embodiment according to FIG. 1, four magnet elements of the devices 3 for generating a magnetic field M are arranged equidistantly at the circumference of the shaft 2.

As a result, the devices 3 emit magnetic fields M that can be detected by external sensor devices 11.

In the shown embodiment, four sensor devices 11 are arranged at the circumference of the sliding bearing 1, wherein the sensor devices 11 have coils in the shown embodiment. In other embodiments, also other magnetic field sensors, e.g. Hall sensors or magnetoresistive sensors, can be used. In principle, these sensors can work in a contact-free manner, so that they can work in a wear-free and reliable way.

When the shaft 2 rotates inside the sliding bearing 1, a voltage U(t) is respectively induced by the generated magnetic fields M.

If a coil is used in the sensor device 11, the following applies with respect to the induced voltage U(t)

$$U ( t ) = - N \frac{d ( A ( t ) B ( t ) )}{dt}$$

with the number of windings N, the cross-sectional surface of the coil A(t) (i.e. the possibly time-varying cross-sectional surface) and the magnetic flux density B (also referred to as the magnetic induction). Here, the magnetic flux density B can be constant over time, time-varying and/or can be variable across the distance (e.g. the clearance).

Through the rotational movement of the shaft 2, the induced voltage U(t) is respectively registered in the sensor devices 11. At that, amplitudes occur in the voltage signal U(t) due to the rotational movement.

Since the absolute positions of the devices 3 for generating the magnetic fields M and of the sensor devices 11 are known, the spatial arrangement of the shaft 2 and the sliding bearing 1 relative to each other can be deducted based on the amplitudes of the voltage signal U(t). In particular, the clearance S can be deduced. Also, the rotational speed of the shaft 2 can be deduced.

FIG. 1A schematically shows a device 3 for generating a magnetic field M. Here, the device 3 generates a divergent magnetic field M that is emitted outwards. A sensor device 11 will measure a flux density B(t) depending on the distance from the device 3 for generating the magnetic field M. If the distance is larger (i.e. a larger clearance S is present), the magnetic flux density B(t) will be smaller than if the distance is smaller (i.e. a smaller clearance S is present). In this manner, the amplitude of the voltage signal U(t) is influenced correspondingly to the above differential equation.

The determined voltage data are transmitted to a data processing device 20 and, if required, are processed (e.g. filtered or averaged) there. The data processing device 20 can create a data set 21 that, due to the voltage data, contains a statistic for the spatial arrangement of the static element 1 (here of the sliding bearing) relative to the movable element 2 (here the shaft).

In the embodiment according to FIG. 1, the devices 3 for generating the magnetic field M are distributed symmetrically at the circumference of the shaft 2. In principle, it is also possible to symmetrically arrange two, three, five or more such devices 3 at the circumference. Embodiments with asymmetrical arrangements are also possible for coding, which is e.g. described in connection with FIG. 3.

In principle, a device 3 for generating a magnetic field M can also be used, in particular if this one element is adjusted to the expected load.

Also, here the devices 3 for generating the magnetic fields M are shown as areas with a rectangular cross section. In other embodiments, also other cross-sectional shapes, such as e.g. round shapes, can be used.

FIG. 1A shows an alternative to the embodiment according to FIG. 1. Here, the sliding bearing device 10 has a movable element, namely the sliding bearing shell. In that case, the shaft 2 is arranged as a static element inside the sliding bearing. As a result, the shaft 2 and sliding bearing 1 are movable relative to each other.

As a modification of the embodiment of FIG. 1, in the embodiment of FIG. 1A, the devices 3 for generating the magnetic fields M are arranged externally inside the sliding bearing shell 10. The sensor devices 11 are arranged at the circumference of the shaft 2.

Otherwise, the functional principle of this embodiment corresponds to the embodiment according to FIG. 1, so that the corresponding description may be referred to. In FIG. 1A, the detection of the voltage signals U(t) is omitted for reasons of clarity. This is performed analogously to the embodiment according to FIG. 1 by means of the sensor devices 11 at the static element, here the shaft 2.

However, in another embodiment, the symmetrical arrangement of the devices 3 for generating the magnetic fields M is deliberately abandoned. FIG. 2 shows such an embodiment as a variation of the embodiment according to FIG. 1. The basic functional principle corresponds to the embodiment according to FIG. 1, so that the corresponding description may be referred to.

Here, an additional device 3′ for generating a magnetic field M is provided at a distance D from one of the symmetrically arranged devices 3. Thus, the sensor devices 11 will receive a slightly differently generated voltage signal U(t); what is present here is an arrangement that is coded across the time intervals between the voltage signals. The induced voltage signal U(t) will be periodical. In such an arrangement, due to the asymmetry, it is also possible to obtain information regarding the rotational direction, which, together with the information about the spatial arrangement of the elements 1, 2, also allows to make statements about the operational state.

The embodiment according to FIG. 2 can alternatively also be embodied like the embodiment according to FIG. 1A. The asymmetrical coding would then be arranged on the movable element 2 of the sliding bearing shell. The shaft 2 with the sensor devices 11 would then represent the static element.

In the embodiments according to FIGS. 1, 1A and 2, the devices 3, 3′ for generating the magnetic fields M are respectively arranged in one plane.

FIG. 3 shows a shaft 2 in a perspective manner, being mounted as a static element in a sliding bearing 1 that is not shown therein. The borders of the sliding bearing are indicated as dashed lines in FIG. 3.

Here, two groups G1, G2 of devices 3 for generating the magnetic fields M are arranged at the circumference at different axial positions of the shaft 2. Thus, the devices 3 for generating the magnetic fields M are arranged at least partially across the width of the at least one sliding bearing device 10.

Here, the individual elements in the first group G1 are arranged in a symmetrically equidistant manner at the circumference (i.e. as shown in FIG. 1). In contrast, the individual elements in the second group G2 are arranged asymmetrically (as in FIG. 2), i.e. what is present is a coding across the time intervals. In principle, the second group G2 could also be embodied to be identical to the first group G1.

Thus, the sensor devices 11, which are not shown here, detect the voltage signals U(t) that are created at two different axial positions of the shaft 2. If the shaft 2 has an axial misalignment (e.g. a tilting), the groups G1, G2 will induce different voltages U(t). This indicates that e.g. the clearance S at the position of the first group G1 is formed differently than the clearance S at the second group G2. This makes it possible to determine the axial alignment of the shaft 2 in the sliding bearing device 10. In this way, e.g. the slanted position of the shaft 2 can be detected.

In principle, it is also possible to use more than two groups G1, G2 of devices 3 for generating the magnetic fields M. Also, linear structures extending across a larger axial area of the shaft 2 can be used.

What is common to all embodiments shown do far is that the induced voltage signal U(t) has been obtained in a contact-free manner.

The contact-free detection of induced voltage signals U(t) for determining the spatial arrangement of a movable part 2 relative to a static part 1 can e.g. be used in connection with a gear box device.

A so-called power gearbox in an aircraft engine is an epicyclic gearing device embodied as a planetary gear 30 with multiple sliding bearing devices 10. The power gearbox connects the fan of the aircraft engine to a shaft (e.g. of a low-pressure shaft) as reduction gear.

This is also referred to as a geared turbofan. Here, the fan can be operated at a lower rotational speed than the driving shaft. In this manner, the rotational speeds of the corresponding compressor stages and turbine stages can be considerably increased, which results in an increase of the total pressure ratio; and thus to an improved efficiency.

FIG. 4 schematically shows an axial view of a planetary gear 30 that can be used with a geared turbofan aircraft engine. A housing of the planetary gear 30 has a hollow wheel 33, which is static, wherein five planetary wheels 31 roll as they rotate inside this hollow wheel 33. The planetary wheels 31 are mounted on shafts 35 in a rotatable manner. Amongst each other, the planetary wheels 31 are connected by a rigid planetary carrier (carrier) 32.

In the shown embodiment, a sun wheel 34 of the planetary gear 30 can be driven. This rotational movement is then transferred via the planetary wheels 31 to the carrier 32, via which the driving of the planetary gear 30 is ultimately realized.

Here, embodiments of the device for monitoring a device (here of the planetary gear 30) with at least one sliding bearing device 10 can be used in different ways.

FIG. 4 shows an embodiment in which four devices 3 for generating a magnetic field M are arranged at the front faces of the rotatable planetary wheels 31 that are mounted on the shafts 35 by the sliding bearing devices 10. For reasons of clarity, they are shown only at one of the planetary wheels 31 in FIG. 4. Accordingly, what is to be accomplished here is not the determination of a clearance S, but rather the determination of a spatial arrangement of the planetary wheels 31.

The carrier 32 is static relative to the planetary wheels 31, so that here a sensor device 11 at the carrier 32 can detect the magnetic fields M, i.e., for example a voltage U(t) is induced in a coil of the sensor device 11, which can then be transferred to a data processing device 20, as described above. In this way, the spatial arrangement and the mounting of each of the planetary wheels 31 (including the planetary constellation) relative to the carrier 32 can be monitored. If the planetary wheels 31 respectively have an individual coding (analogous to the embodiment according to FIG. 3), the data processing device 20 can determine the rotational behavior of the planetary wheels—and thus the spatial arrangement—based on different measurement results in the voltage signal U(t). Here, the signals of the planetary wheels 31 and the signals regarding the axial alignment are different.

The carrier 32 can be arranged axially on both sides of the planetary wheels 31, so that sensor devices 11 can also be arranged on both sides. If now the planetary wheels 31 have devices 3 for generating a magnetic field M on both front faces, the sensor devices 11 can perform measurements that allow to gain information regarding the spatial arrangement, in particular the orientation of the planetary wheels 31.

Additionally, in a further embodiment (see FIG. 5), it is also possible to determine the movement of the carrier 32 relative to the housing with the hollow wheel 33, wherein in principle the same operating principle is used. FIG. 5 shows the same configuration as in FIG. 4, so that the corresponding description many be referred to. With a view to simplicity, the details of the detection of the movement of the planetary wheels 31 (see FIG. 4) are not shown here.

The carrier 32 is an element that is movable relative to the static hollow wheel 33 in the housing of the planetary gear 30. Thus, devices 3 for generating magnetic fields M are arranged at the carrier 32. In the shown embodiment, five such devices 3 are provided.

In that case, sensor devices 11 that detect the magnetic fields M are correspondingly arranged inside the housing (now shown in FIG. 5) of the planetary gear 30, so that the rotational movement of the carrier 31 relative to the housing can be detected in a contact-free manner from outside the housing.

Thus, through the detection of the magnetic fields M, information can be obtained from the closed-off gear box housing of the planetary gear 30 without having to transmit electrical signals. Since combustible materials are also always present in aircraft engines, the reduction of electrical signals represents an improvement.

The signal transmission from the interior of the housing can even be realized in yet another manner.

In the embodiment according to FIG. 4, the current spatial arrangements of the movements of the planetary wheels 31 about the respective shafts 35 have been detected by detecting the changes in the magnetic fields M.

In the additional embodiment according to FIG. 5, the current spatial arrangements of the movement of the carrier 32 relative to the housing of the planetary gear 30 have been detected, again by detecting changes in the magnetic fields M.

Now it is possible to combine signal generation with signal transmission that is shown in FIG. 6. Here, two coils are switched “in row”.

If for example the coils of the sensor device 11 at the carrier 32 (see FIG. 4) are magnetically coupled to the device 3 for generating magnetic fields M (see FIG. 5), a single magnetic signal can be generated, which induces a voltage signal U(t) and that can subsequently be detected at the exterior side of the housing of the planetary gear 30.

Since the dynamic of the planetary wheels 31 considerably differs from the dynamic of the carrier 32, the information regarding the two subsystems can be extracted from the modulated total signal by means of a Fourier analysis.

In principle, also other movement patterns with which the embodiments shown herein can be used are possible in a planetary gear 30.

In this way, the carrier 32, the sun wheel 34 or the hollow wheel 33 can respectively be driven. Then, the driving is realized via another of these elements, while the remaining third element is static in that case. Thus, e.g. the hollow wheel 33 can be driven, which sets the planetary wheels 31 into rotation, so that the output via the sun wheel 34 can finally be realized with the carrier 32 being fixated.

FIG. 6 shows a planetary gear 30 with two planetary wheels 31 and a sun wheel 34 in a schematic side view. The planetary wheels 31 are mounted on shafts 35 by means of sliding bearing devices 10. The planetary gear 30 is arranged inside a housing 36, which is shown only schematically in FIG. 6, in particular with the shaft inputs and outputs being omitted.

The planetary wheels 31 are arranged inside the carrier 32 that axially surrounds the planetary wheels 31 at the ends.

In principle, it is possible in this configuration to determine the clearances S of the planetary wheels 31 on the sliding bearings 10, as has been described in connection with FIGS. 1 to 3.

Additionally and alternatively, the spatial arrangements, in particular the orientations of the planetary wheels 31 inside the housing of the planetary gear 30 according to the embodiments of FIG. 4 and/or FIG. 5, can also be detected.

FIG. 6 now shows a further embodiment that can be used alternatively or in combination with the other embodiments.

For this purpose, the planetary wheels 31 have devices 3 for generating the magnetic fields M at both ends. Alternatively, the devices 3 for generating the magnetic fields M can also be arranged on the shafts 35.

In FIG. 6, for reasons of clarity, these devices are shown only at one planetary wheel 31, and also respectively only one device 3 is shown. With the planetary wheels 31, the devices 3 rotate about the shafts 35 relative to the carrier 32. First coils 11′ are arranged at the carrier 32 as parts of a sensor device 11. The first coils 11′ have a comparatively large diameter, corresponding to the diameter of the carrier 32.

At the first coils 11′, second coils 11″ are respectively arranged in such a manner that they can detect the magnetic fields M of the devices 3 for generating the magnetic fields M. Due to the relative movement between the devices 3 for generating the magnetic fields M and the second coils 11″ with respect to each other, a voltage U₂ is respectively induced (analogously to e.g. FIG. 1A) in the second coils 11″. These voltages respectively induce a current flow I in the first coil 11′.

The voltages are generated by the modification of the magnetic flux

$${U}_{1} = - \frac{d {θ}_{1}}{dt}$$

in the first coil 11′. As a result, a current is generated that flows through the first coil 11′ and the second coil 11″, which in turn generates a changing magnetic field in the second coil 11″. This ultimately generates the voltage U₃ in a third coil 11′″:

$${U}_{3} = - \frac{d {θ}_{2}}{dt}$$

At the housing 36, third coils 11′″ are arranged in a stationary manner as a part of the sensor device 11. The second coils 11″ in the carrier 32 move relative to the third coils 11′″, so that a voltage U₃ is respectively induced inside them.

These voltage signals U₃ can then be transmitted to a data processing device 20, which is not shown herein.

With this embodiment, it is possible to obtain information regarding the spatial arrangement of the planetary wheels 31 inside the housing 36 of the planetary gear 30 by wireless means.

At that, the devices 3 for generating the magnetic fields M can be embodied in such a manner that the planetary wheels can be coded in an individualized manner, as it has e.g. been described in connection with FIG. 2. The devices 3 for generating the magnetic fields M can be arranged on the planetary wheels 31 in the form of patterns that can be individualized. The width of the magnetic areas can e.g. correspond to the size of the clearance to be measured. The magnetic areas can e.g. be realized in the form of a magnetizable area, analogously to a magnetizable surface in a hard drive.

Thus, in the event of a relative movement of the planetary wheels 31 with respect to the carrier 32, individually different voltage signals are generated, which generate a special signal in the second coils 11″. The data processing device 20 can subsequently analyze the individual contributions of the planetary wheels 31 to this signal.

In these embodiments, planetary gears with five planetary wheels 31 have been used. Alternatively, instead of five planetary wheels, three or four, or also more than five planetary wheels can be used. These principles can also be transferred to other epicyclic gearings, such as e.g. assembled epicyclic gearings or assembled planetary gears (i.e. two or more exterior connecting shafts).

It is also possible to arrange a disc with magnetic data on the movable element 1 of the bearing. In that case, a magnetic reading head that is reading the data is arranged on the static element 2.

### PARTS LIST

1 static element, e.g. sliding bearing, shaft for the planetary wheel, carrier
2 movable element, e.g. shaft, planetary wheel, carrier, sliding bearing shell
3, 3′ device for generating a magnetic field
10 device to be monitored, sliding bearing device
11 sensor device
11′ first coil
11″ second coil (at the carrier)
11′″ third coil (at the housing)
20 data processing device
21 data set
30 planetary gear
31 planetary wheel
32 carrier
33 hollow wheel inside the housing of the planetary gear
34 sun wheel
35 shaft for the planetary wheel
36 housing for the planetary gear
A surface that is penetrated by the magnetic flux
B magnetic flux density
D distance between two devices for generating a magnetic field
G1 first group of devices for generating a magnetic field
G2 second group of devices for generating a magnetic field
I(t) current that is created by the induced voltage
M magnetic field
S clearance
U(t) induced voltage signals
Θ magnetic flux (B*A)

1. A device for monitoring a device with at least one sliding bearing device with at least one static element for at least one element that is movable in a rotatory manner relative to the at least one static element,
wherein
the at least one movable element has at least one device for generating a magnetic field and the at least one static element has at least one sensor device for detecting the magnetic field, in particular a time-varying magnetic field, wherein data of the magnetic field detected by the sensor device in particular in a contact-free manner can be transmitted to a data processing device during operation of the at least one device and at least one statistic for a spatial arrangement of the at least one static element relative to the at least one movable element can be determined with the data processing device based on the detected data.

2. The device according to claim 1, wherein the spatial arrangement between the at least one static element and the at least one movable element is characterized by
a clearance between the at least one static element and the at least one movable element,
a measure for the alignment, in particular the axial alignment, the radial orientation and/or the orientation between the at least one static element and the at least one movable element,
a phasing,
a rotational direction of the at least one movable element and/or
the rotational speed of the at least one movable elements.

3. The device according to claim 1, wherein the device for generating a magnetic field has at least one magnet element, in particular at least one magnet element that is enclosed in the at least one movable element, a magnetized area externally introduced into the movable element, at least one coil enclosed in the at least one movable element and/or at least one permanent magnet or magnetic area enclosed in the at least one movable element.

4. The device according to claim 3, wherein the device for generating the magnetic field has a coded magnet element, in particular a sequence of magnets or a sequence of magnetic areas, for the differentiation of the rotational direction of the at least one movable element and/or for the individualization of the movable element.

5. The device according to claim 1, wherein the at least one device for generating a magnetic field is arranged at least partially across the width of the at least one sliding bearing device.

6. The device according to claim 1, wherein the sensor device has at least one coil for detecting the magnetic field, in particular the time-varying magnetic field, at least one Hall sensor, a magnetic reading head and/or at least one magnetoresistive sensor.

7. The device according to claim 1, wherein the amplitude curve of the time-varying magnetic field can be determined with the data processing device.

8. The device according to claim 1, wherein the at least one static element is a carrier in an epicyclic gearing, in particular a planetary gear, and the at least one sensor device is arranged at a carrier of the epicyclic gearing.

9. The device according to claim 8, wherein the at least one movable element is arranged at least at one planetary wheel of the epicyclic gearing, in particular of the planetary gear, so that a movement of the at least one planetary wheel relative to the carrier can be detected by the at least one sensor device at the carrier.

10. The device according to claim 1, wherein the at least one static element is a housing of the epicyclic gearing, in particular of the planetary gear, or is arranged at the housing, and the carrier is the element that is movable relative to the housing, so that a relative movement of the carrier with respect to the housing can be detected by at least one sensor device.

11. A turbomachine, in particular an aircraft engine, with at least one device according to claim 1.

12. A method for monitoring at least one device with at least one sliding bearing device with at least one static element for at least one element that is movable in a rotatory manner relative to the at least one static element,
wherein
a) the at least one movable element generates a magnetic field by means of at least one device,
b) the at least one static element has at least one sensor device that detects the magnetic field, in particular the time-varying magnetic field, wherein
c) data of the magnetic field of the device that are detected, in particular in a contact-free manner, by the at least one sensor device are transmitted to a data processing device and
d) the data processing device determines at least one statistic for a spatial arrangement of the at least one static element relative to the at least one movable element based on the detected data.
